(19) United States
(12) Patent Application Publication
(10) Pub. No.: US 2002/0054593 A1
(43) Pub. Date: May 9, 2002

(54) Access network system

(76) Inventors: Tomoo Morohashi, Tokyo (JP); Hideki Mori, Chiba (JP)

Correspondence Address: FLYNN, THIEL, BOUTELL & TANIS, P.C., 2026 Rambling Road, Kalamazoo, MI, 49008-1699, US

(21) Appl. No.: 10/035,509

(22) Filed: Oct. 25, 2001

(30) Foreign Application Priority Data
Oct. 26, 2000 (JP) 2000-326397

(51) Int. Cl. H04L 12/50

(52) U.S. Cl. 370/386; 370/401

(57) ABSTRACT

In order to provide an access network system that has durability against transmission quality deterioration and fault and controls the causes of delay in the communication processing for data transmission, the base stations (communication nodes) are arranged in a plurality of cross-points, and the base stations have a function capable of transmitting and receiving the information of an optical wireless communication type and the like, and are mutually linked with each other by wireless and constitute an access network which is accessible cross-wise from each base station by a wireless communication link passage. This access network is wirelessly connected to other outside communication network by an access network terminating set.

### BACKGROUND OF THE INVENTION

1. Field of the Invention

The present invention relates to improvements of an access network system such as a communication network system having a mesh structure utilizing wireless transmission such as free space optical transmission and the like, and more in particular to an algorism suitable for performing a routing for communication fault countermeasure and effective information transmission which communication protocol and each communication node (base station) execute.

2. Description of the Related Art

In a telecommunication network, when a circuit (link circuit) from a switched network to a base station housing subscribers is constructed with wireless communication as a medium, circuit quality is largely influenced by interference and atmospheric phenomenon and, since the base station located far away from a switchboard requires a base station which relays a wireless circuit due to a problem of range, a delay in communication processing for transmission increases. Moreover, in the case where the circuit that connects each base station and the switchboard is one route only, if circuit quality fault and communication device fault occur, they lead to extreme deterioration of transmission quality or circuit disconnection so that it is impossible to maintain the communication itself.

In the technology of the prior art for solving the problems, there are an auxiliary circuit system, a signaling system and information exchange system in a circuit status.

The auxiliary circuit system is a communication system using a leased circuit, which provides an auxiliary circuit and copes with a fault by switching to the auxiliary circuit from the current circuit when the fault occurs.

In contract to this, in a switchboard network (backbone network), a system such as signaling system and the like is used wherein a new circuit is provided in a route in which a faulty place is detoured or wherein information relating to a circuit status is exchanged among communication devices.

In the system wherein a new circuit is provided in a route which detoured the faulty place, the switchboard that detected the fault notifies other switchboards of a message in conformity with the signaling system, and the switchboard that received that message determines whether it is possible to take an effective measure for restoring the circuit and, furthermore, performs transmission of the message to other switchboards. These processes are continued until reaching the switchboard, which can avoid the faulty place and construct a newly restored circuit, and the result thereof is notified to the original switchboard and, when restoration of the circuit is confirmed, a new circuit is established.

In the system for exchanging the information relating to the circuit status among the communication devices, some switchboards notify the information to other switchboards periodically or when a fault occurs (when a change occurs in the structure in the network). The notifying range of the information is in the vicinity or a part limited to a certain range or the whole of the switched network and, when notification thereof is completed, the network information adapted for the current status of the switched network is known to each switchboard so that correct operation can be continued.

However, in the system using the auxiliary circuit, since it is necessary to provide a circuit which is equal to or can be determined to be equal to the current circuit simultaneously with the current circuit being operated, the auxiliary system is not preferable in view of the cost involved in the operation of the network.

While, in the signaling system, in order to cope with a fault, the time that required from detecting the fault to restore the circuit is great. This is because of the delay in the process, wherein the switchboard itself that detected the fault or the switchboard that notified that it detected the fault activates a process for restoring the circuit and generates a message for that purpose and transmits it to the switchboard in which no fault occurs, or because of the addition of processes such as a judgment as to whether the switchboard that received the message for restoring the circuit is in an effective state for restoring the circuit, further transfer of the message to other switchboards, a response to the switchboard that transmitted the message for restoring the circuit and the like.

In the case of the system for exchanging the information relating to the circuit status among the communication devices, when the status of one circuit is changed, that information is required to be transmitted to all the switchboards in many cases. In order for that information to be transmitted, transmission of information relating to the circuit status is required, and it takes a time until that information is notified to all the switchboards. When a packet flowed before the information relating to that circuit status is transmitted to all the switchboards or in the course of being transmitted after the circuit status changed, it is sometimes transmitted to the circuit with its circuit status changed or routed into a wrong route.

Moreover, in this system, since a transmission path or a transmission bandwidth for exchanging the information relating to the circuit status among the communication device is required, the construction of an exclusive transmission path or bandwidth is required.

Nevertheless, the access network is required to connect the base stations housing subscribers and the switched network with high reliability and yet to be controlled to a low delay. Further, in order to provide high serviceability for user, it is essential to construct and operate the network at low cost.

### SUMMARY OF THE INVENTION

An object of the present invention is to provide the access network system, wherein each base station (communication node) is provided with a function capable of constructing a plurality of wireless communication circuits (communication link passages), an interval between the base stations are connected by the wireless communication circuits so as to construct a network (an access network) which is taken as a link circuit, the network is connected in a cross state, each base station is constructed in such a manner as to physically secure a plurality of routes as the route to the switchboard, and by using this route, durability for transmission quality deterioration and fault is maintained, and yet a delay occurrence factor is controlled.

In order to achieve the object, the access network system of the present invention has communication nodes capable of receiving and transmitting the information disposed at a plurality of cross points, wherein each communication node mutually constitutes the access network accessible in a cross state at the communication link and comprises an access network terminating set for terminating the access network, the access network terminating set comprising: means for constructing a plurality of connection communication passages having a logical tree structure which hypothetically connects each communication node on the communication passages, means for notifying all the communication nodes of the information relating to the constructed connection communication passages, means for controlling communication traffics allotted to the plurality of connection communication passages and changing allotment conditions of communication traffics among the connection communication passages; means for receiving the information relating to the disable or enable status change from the communication node; and means for terminating the communication processing inside the access network and executing a gateway function with an outside network.

Furthermore, in the access network of the present invention, the communication node may be constructed in such a manner as to comprise: means for judging the disable or enable status of the communication link passage connected to itself; means for notifying the access network terminating set of the judgment result of that means; and means for receiving the information relating to the connection communication passages notified from the access network terminating set and adopting it as a route information.

Moreover, the communication node may have means for independently performing the switching of the connection communication passages when the disable or enable status of the above communication link has changed.

A practical action of the access network system of the constitution of the present invention is as follows.

On a physical circuit connection of the access network, a plurality of connections (virtual connection trees) having a logical tree structure is prepared. One connection passes through all the communication nodes one time only. The user data that flows on the access network is transmitted through one route inside a plurality of virtual connection trees.

The access network terminating set has the information relating to the physical structure of the access network, and prepares a plurality of connections (virtual connection trees) having a logical tree structure. The access network terminating set notifies each communication node of the prepared information.

The communication node prepares the route information (routing table) from the received information relating to the connections (virtual connection trees) having a logical tree structure.

Since the user data is transferred inside the access network system, it has communication header information. The header information is provided with an information Tree-ID that identifies the virtual connection trees, and each communication node transmits the user data to the root of the virtual connection tree shown by the information Tree-ID according to the content of the information identified by the information Tree-ID.

Since the header information is also provided with information destination MN-ID (information showing a communication node) regarding to which communication node the user data is transmitted, when the user data relayed on the virtual connection tree arrives at a communication node which the information of the communication node indicates, the relay is completed by that communication node and the user data is received by that communication node.

The communication node has the route information (routing table) and link status information (link condition table). The routing table shows the correspondence between a plurality of links, which construct a mesh structure, and a plurality of virtual connection trees, with which the access network is provided. That is, an upper side link of a certain virtual connection tree of a certain communication node (link close to the access network terminating set on the virtual connection tree) can be specified, and a lower side link (link far away side from the side of the access network terminating set on the virtual connection tree) can be also specified. The link condition table manages the operational status of a plurality of links connecting to communication nodes in each communication node.

The communication node always monitors the status of the link between the communication nodes necessary for constituting the access network, and when a link disconnection due to a link fault or anode fault is detected, the content thereof is immediately notified to the link condition table which manages the link status inside the communication node.

When the communication node transmits or relays the user data, it looks at the header information, which identifies the virtual connection trees, so that it can decide to which link that user data is transmitted from the routing table and transmits it accordingly.

After the communication node decides the link to be transmitted from the routing table, the disable or enable information of that link is acquired from the link connection table in order to confirm a status of that link. When the link is found to be in an operating status from that information, the user data is transmitted.

When the communication node transmits the user data, if that link of the link condition table is in a non-operating status, the communication node sets and changes the content of the information which identifies the virtual connection trees existing in the header information of that user data to the content which identifies other virtual connection, and confirms all over again a link transmittable and its status from the routing table and the link condition table.

When a link suffers from a fault, the communication node connected to that link notifies the access network terminating set of the disable or enable status of that link. Conversely, when the link restores, the same process is repeated.

The access network terminating set has the information relating to the constitution of the access network, and, when it receives the information of the disable or enable status of the link, it updates the information relating to the physical structure of the access network.

The access network terminating set can restructure the virtual connection trees from the change of the constitution of the access network, and newly notifies the communication nodes of the information regarding that re-structure so that the access network can be operated again with new virtual connection trees.

The communication processing according to the system of the present invention can be realized by a low degree layer of the communication protocol. It is possible to make an instantaneous route switching for link disconnection and the like due to link fault or node fault, and evasion of the fault is possible in a short-term view. Moreover, depending on the operating status of the communication link passages that connect the intervals among the communication nodes of the connection communication passages having a logical tree structure, having a re-structuring method can evade the fault in a long-term view.

### BRIEF DESCRIPTION OF THE DRAWINGS

FIG. 1 is the whole outline of the access network of the present invention; 331 FIG. 2 is a block diagram of the essential part of a communication node of the present invention;

FIGS. 3(a) to (d) are examples of the construction of the access network and virtual connection trees;

FIG. 4 is a view showing a part of the access network for explaining the embodiments of the present invention;

FIG. 5 is a view of a routing table that a routine information section of the communication node has in possession;

FIGS. 6(a) to (b) are views of a link condition table which a link status monitor section of the communication node has in possession;

FIG. 7 is a view showing a correspondence between a Tree-ID that a tree number information section of the communication node has n possession and an OMS-ID, a MN-ID of own station and an User-ID;

FIG. 8 is a view showing a correspondence between a PPP path ID which a drop information section of the communication node has in possession and the OMS-ID, the MN-ID of own station and the User-ID;

FIG. 9 is a view of the format of a header information which is set in the user data necessary for the communication processing of the present invention;

FIG. 10 is a view showing the header information for explaining a first embodiment of the present invention;

FIGS. 11(a) to (b) are views showing the header information for explaining a second embodiment of the present invention;

FIG. 12 is a main process flow chart for a routing process inside the communication node;

FIG. 13 is a relay flow chart for the routing process inside the communication node;

FIG. 14 is a view of a fault flow A for the routing process inside the communication node;

FIG. 15 is a view of a fault flow B for the routing process inside the communication node; and

FIG. 16 is a view of a fault flow C for the routing process inside the communication node.

### DESCRIPTION OF THE PREFERRED EMBODIMENTS

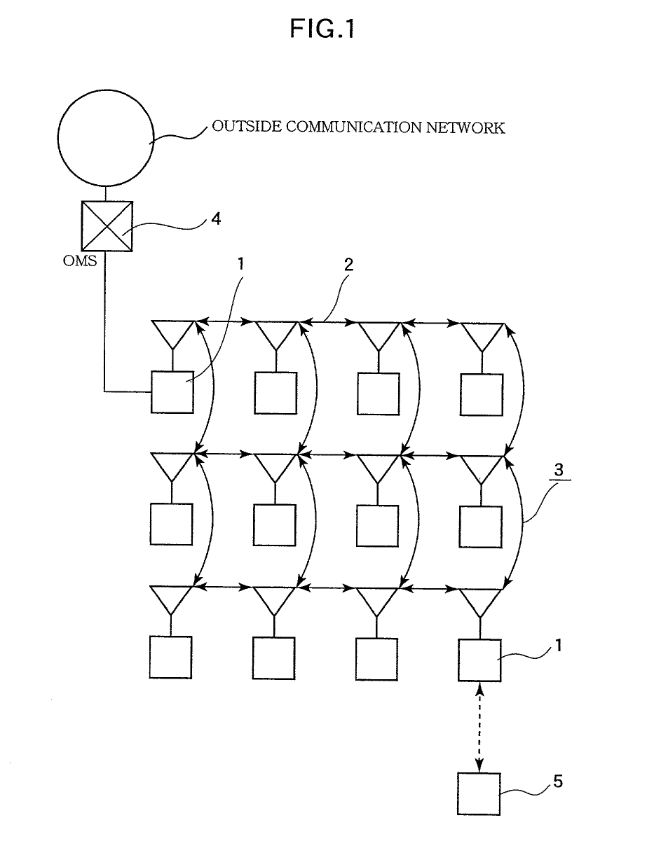

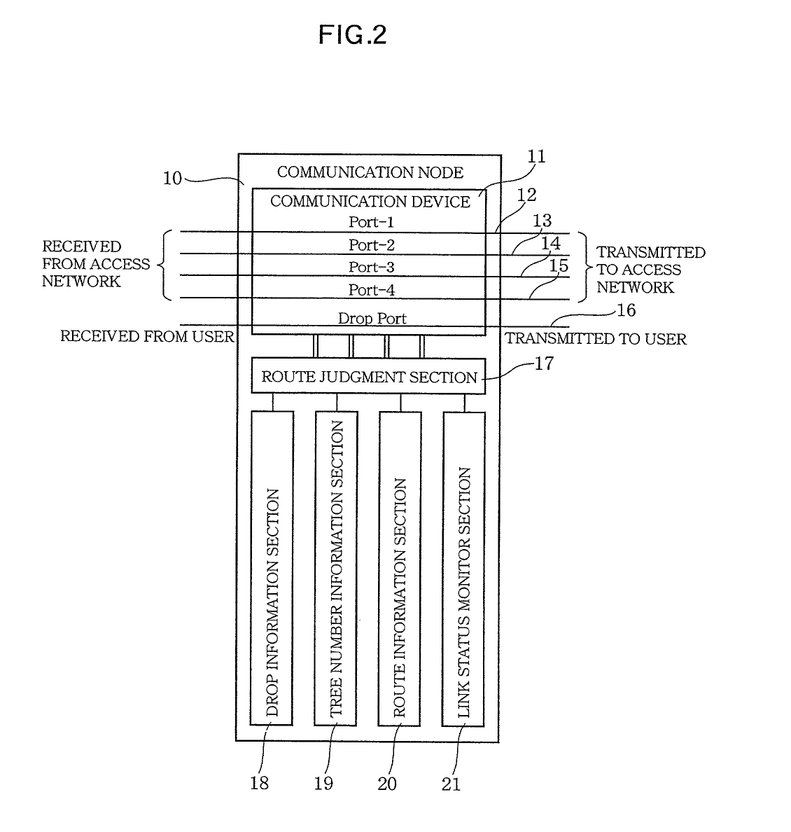

FIG. 1 shows an example of the schematic block diagram of the whole of the access network of the present invention. In the drawing, reference numeral 1 denotes base stations, which are disposed at a plurality of cross-points and, for example, have a function capable of transmitting and receiving data on an free space optical communication system and the like. The base stations are mutually connected by wireless communication and, therefore, constitute an access network 3 which is accessible cross-wise from each base station 1 by a communication link passage 2. That is, the base station 1 is the communication node that is located in each cross-point of the access network 3.

Reference numeral 4 denotes an access network terminating set which takes the access network 3 as termination, and is connected to the outside other communication network. The access network terminating set 4 constitutes: means for constructing a plurality of connection communication passages having a logical tree structure which hypothetically connects each communication node 1 on the communication link passage 2 to be hereinafter described by CPU, a memory, wireless communication transmitting and receiving circuit and the like; means for notifying all the communication nodes of the information relating to the constructed connection communication passages; means for managing communication traffics allotted by the plurality of connection communication passages and changing the communication traffic allotment conditions among the connection communication passages; means for receiving the information relating to the disable or enable status change from the communication nodes; means for terminating the communication processing inside the access network and executing a gateway function with the outside network; and the like.

Reference numeral 5 denotes the user of the communication node 1.

FIG. 2 is a block diagram of an essential part of the communication node 10 in the present invention. Since the communication node 10 constitutes the wireless communication link passages with other communication nodes, it comprises: a transmitter-receiver communication device 11; a route judgment section 17; a drop information section 18; a tree number information section 19; a route information section 20; and a link status monitor section 21. The communication device 11 has ports (Port) 12 to 15 which transmit and receive the information from the access network and a drop port (Drop Port) 16 which transmits and receives the data from the user.

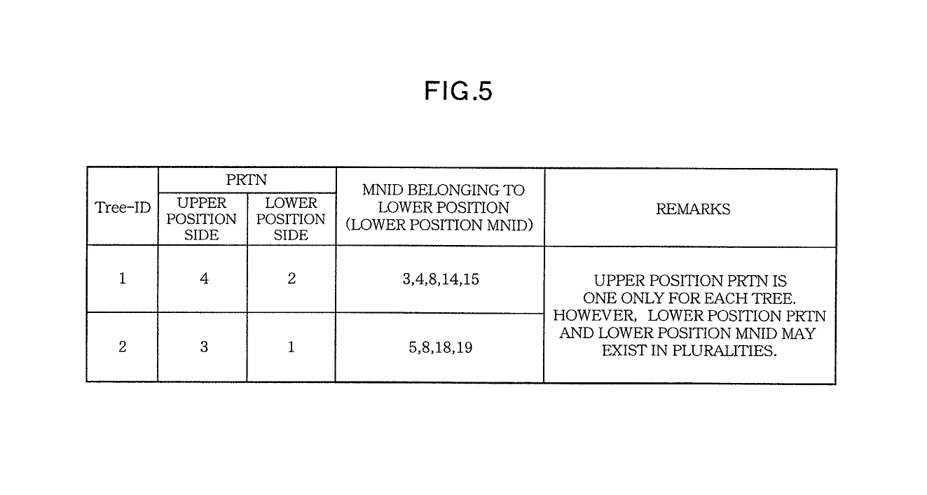

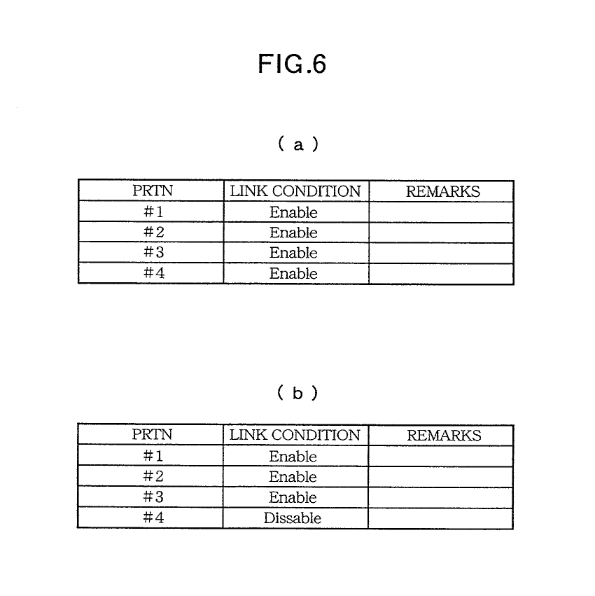

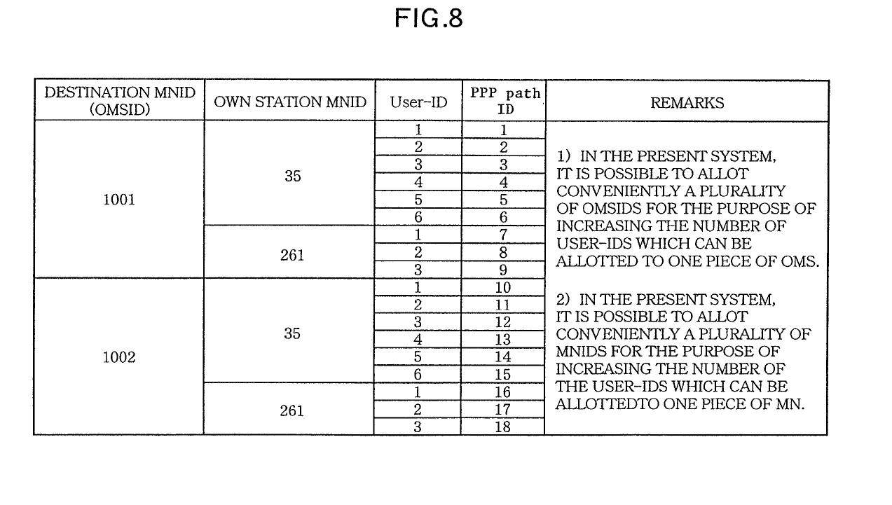

The route judgment section 17 decides the Ports 12 to 15 or the Drop Port 16 to which the user data must be transmitted by referring to various kinds of the information that the communication node has in possession. The link status monitor section 21 monitors the disable or enable status of all the links of the communication nodes, and maintains the information (link condition table) as shown in FIG. 6. The route information section 20 maintains the information (routing table) relating to the virtual connection trees shown in FIG. 5. The drop information section 18 maintains the information (PPP path ID) added to the user data when the user data shown in FIG. 8 was received and the information (an OMS-ID, a MIN-ID of own station and a User-ID) necessary for transmitting to the access network. The tree number information section 19 maintains the information (Tree-ID) necessary for transmitting the user data to the access network and above described information (the OMS-ID, the MIN-ID of own station and the User-ID). The communication nodes know of the MN-ID of own stations and the OMS-ID.

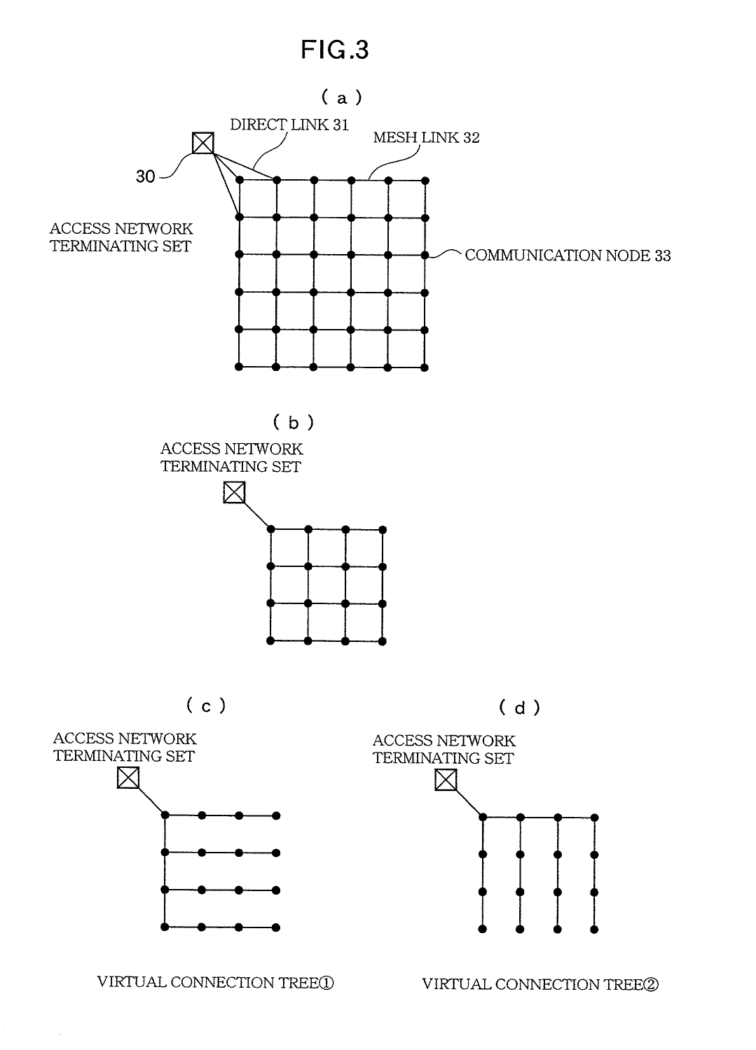

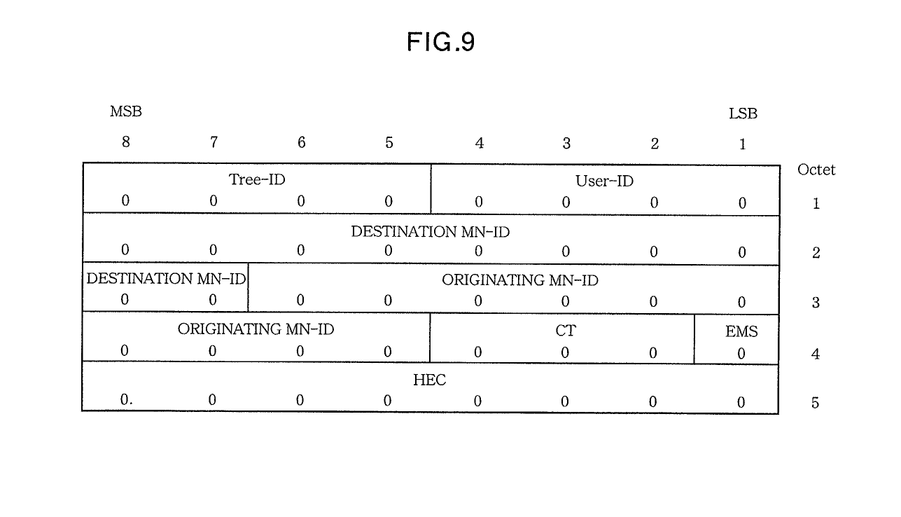

Incidentally, FIGS. 9 to 11 show the header information used for data transmission by the packet base of the present invention, wherein the Tree-ID is an identifier for distinguishing the connection communication passage (FIG. 3) having a logical tree structure, an originating MN-ID is the identifier for showing an originating cell (packet) transmission, a destination MN-ID is the identifier for showing the destination of transmission, the User-ID is the identifier for distinguishing the user connected to the communication node, a CT is the identifier for showing the type of the cell (user traffic cell, maintenance cell and the like), an EMS is the identifier for showing the cell which does not have an adequate logical connection at the time a fault occurs, and a HEC is a header error check information.

FIG. 3 shows an access network 2 and one example of the virtual connection trees constructed on the network. FIGS. 3A and 3B show one example of the trees respectively, which show a physical wireless communication connection status of the link. In FIG. 3A, reference numeral 30 denotes an access network terminating set, reference numeral 31 a wireless communication circuit (direct link) which connects the access network 2 and the access network terminating set 30, reference numeral 32 a communication link passage (mesh link) which connects the intervals among the communication nodes inside the access network, and reference numeral 33 a communication node. FIGS. 3C and 3D show one example of the connection communication passages having a logical tree structure, respectively. The logical connection communication passage can be prepared by any quantity, and each connection communication passage is assigned with a number, and the user data is set with that number so that it can be transmitted on each connection communication passage.

In the access network 2, as shown in FIG. 3A, there exist communication nodes 33 and an access network terminating set 30. The access network terminating set 30 is a gateway for the access network 2, which is actually a device for terminating the protocol which acts on the virtual connection trees and removes interface with the outside network. In the access network 2, transmission pattern of the user data is limited only between each communication nodes 33 and the access network terminating set 30, and the user data that was generated from the communication nodes is not received by the communication nodes.

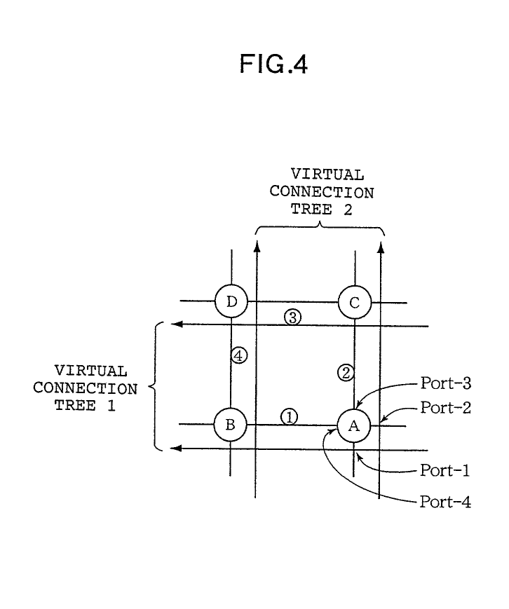

FIG. 4 shows a part of the virtual connection trees. In FIG. 4, reference symbols A to D denote the communication nodes, and the communication link passage of each communication node is assigned with the port numbers 1 to 4 similarly to the communication node A, and in this way it is possible to coordinate the virtual connection trees with the communication link passages of the communication nodes. With respect to the virtual connection trees □ and □ in the four communication nodes arranged in the center of the access network, the correspondence between the communication node A and the port numbers are as shown in FIG. 5.

In the communication nodes of FIGS. 3C and 3D, a side close to the side of the access network terminating set 30 is defined as an upper position side, and a side far away as an lower position side.

FIG. 5 shows a routing table, which the route information section 20 has in possession. In the same drawing, what is meant by the lower position MN-ID is the information of the communication nodes situated in the lower position side of the communication nodes on each virtual connection tree. Usefulness of this information will be hereinafter described.

FIG. 6 shows a link condition table, and the link condition in the same drawing shows the information relating to the disable or enable status of the communication link passage having the port number numbers (PRTN)#1 to #4.

FIG. 8 is a corresponding table of the PPP path ID and the OMS (access network terminating set)-ID, the MN-ID of own station and the User-ID, which the drop information section 18 has in possession. It shows a correspondence between the information (PPP path ID) added to the user data and the information (the OMS-ID, the MN-ID, and the User-ID) necessary to be transmitted by the access network. When a data is transmitted and received between the communication node and user, this PPP path ID is added. In this way, the communication node can identify the user and, based on this information, the user (destination) can be specified at the access network terminating set side. In the case of a return route, the same process is repeated.

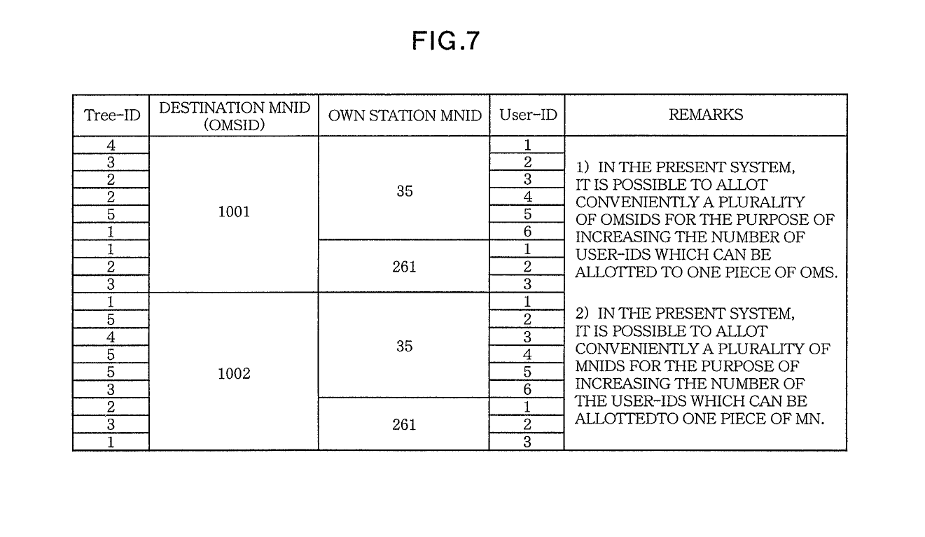

FIG. 7 is a corresponding table of the Tree-ID, the OMS-ID, the MN-ID of own station and the User-ID, which the tree number information section 19 has in possession. It shows a correspondence between the information (the OMS-ID, the MN-ID, the user-ID) necessary to be transmitted by the access network and the virtual connection tree numbers. In this way, the communication node can decide the virtual connection tree to be used for transmission of the user data.

FIG. 9 shows a format of the header information to be added to the user data necessary for the communication processing to be transmitted on the access network. The information shown in FIGS. 7 and 8 is all provided in the appropriate places of the header. The CT is the information that has nothing to do with the present invention. The EMS (Emergency Status) will be hereinafter described.

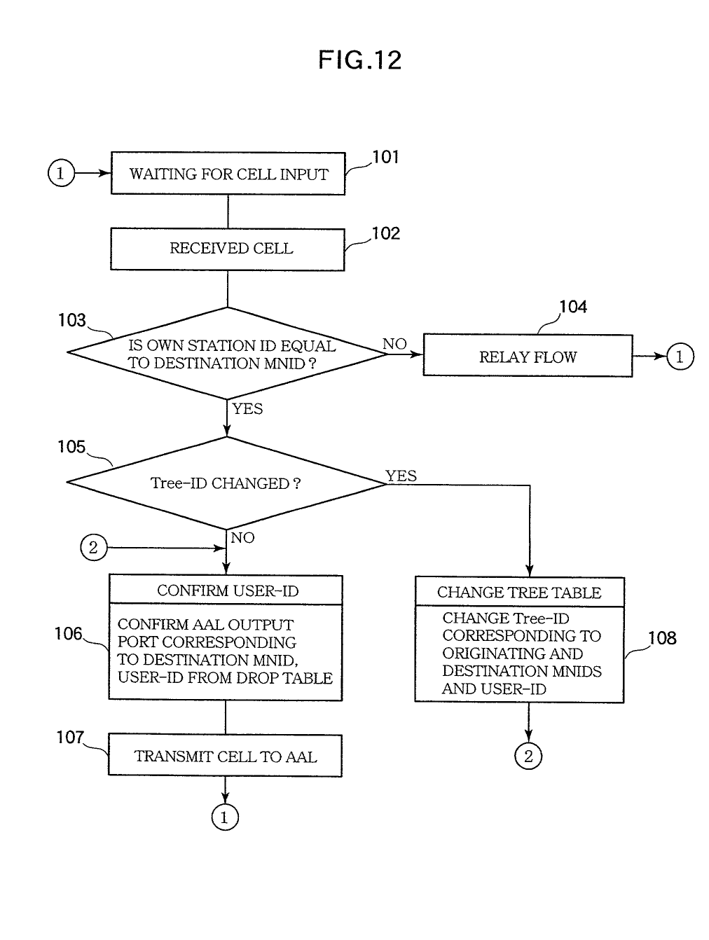

FIG. 12 is a main process flow chart for a routing process inside the communication node. When the user data is transmitted to the communication node 10 (101, 102), the routine judgment 17 determines whether the destination MN-ID matches the MN-ID of own station (103). When it matches, this communication node transmits the destination MN-ID to a receiving user side. Next, the Tree-ID, the originating MN-ID, the User-ID and the destination MN-ID are read from the header information, and the tree number information section 19 determines whether the Tree-ID which is a combination of the originating MN-ID, the User-ID and the destination MN-ID matches the value of the Tree-ID of the header (105). When it matches, it is transmitted to the user side as it is. When it does not match, it is re-written to the value of the Tree-ID of the header by the tree number information section 19 (108). After that, it is transmitted to the user side.

When the destination MN-ID inside the header does not match the MN-ID of own station, the user data enters a relay flow (104, 121) and is determined as an EMS (122). When the EMS information is taken as [0], the user data enters a relay flow (124) and, when the EMS information is taken as [1], it enters a fault flow A (123).

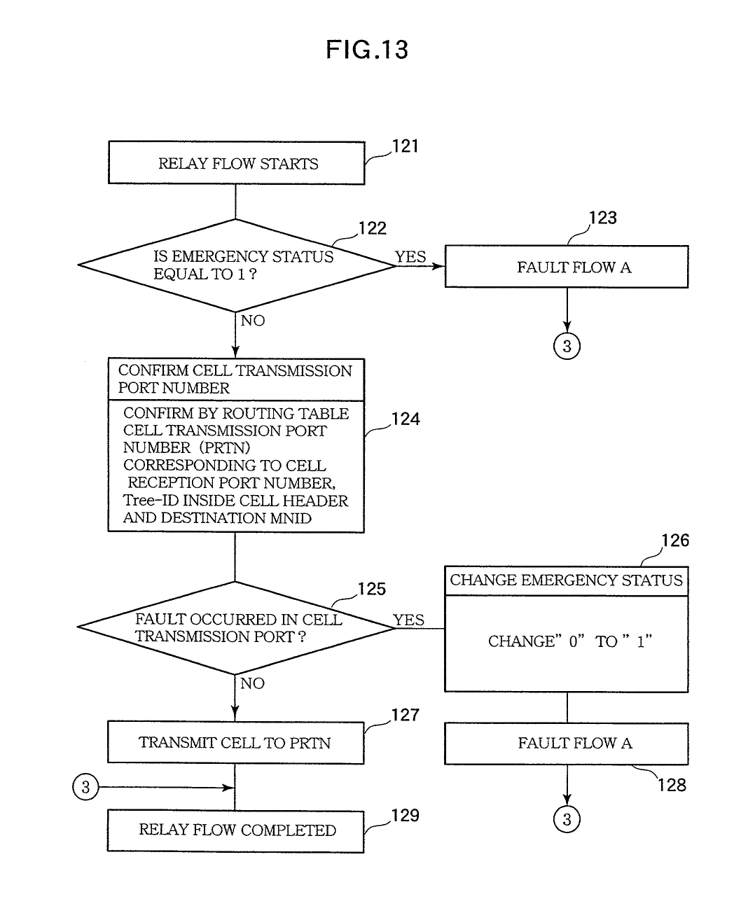

FIG. 13 is a relay process flow chart for the routing process inside the communication node. This relay flow inquires the routine information section 20 of the port number to be relayed from the value of the port numbers and the Tree-ID inside the header in which the user data was received (124). The routine information section 20 returns the corresponding port number (retrieved from the routing table of FIG. 4) to the relay flow from the information. However, when the port number in which the user data was received is at the upper position side, the lower position MN-ID information is confirmed and the value of the destination MN-ID inside the header is confirmed to exist inside the lower position MN-ID information. Moreover, when the lower position side is branched, the destination MN-ID selects the port at the side that exists in the lower position MN-ID information.

Next, the routine judgment section 17 inquires the link status monitor section 21 of the disable or enable status of that port number (125). When that port number is in an operating status, the port is determined to be capable of transmitting the user data and the data is transmitted (127). When the port number is in a non-operating status, the EMS information inside the header is changed to [1](126), and the user data enters the fault flow A (128).

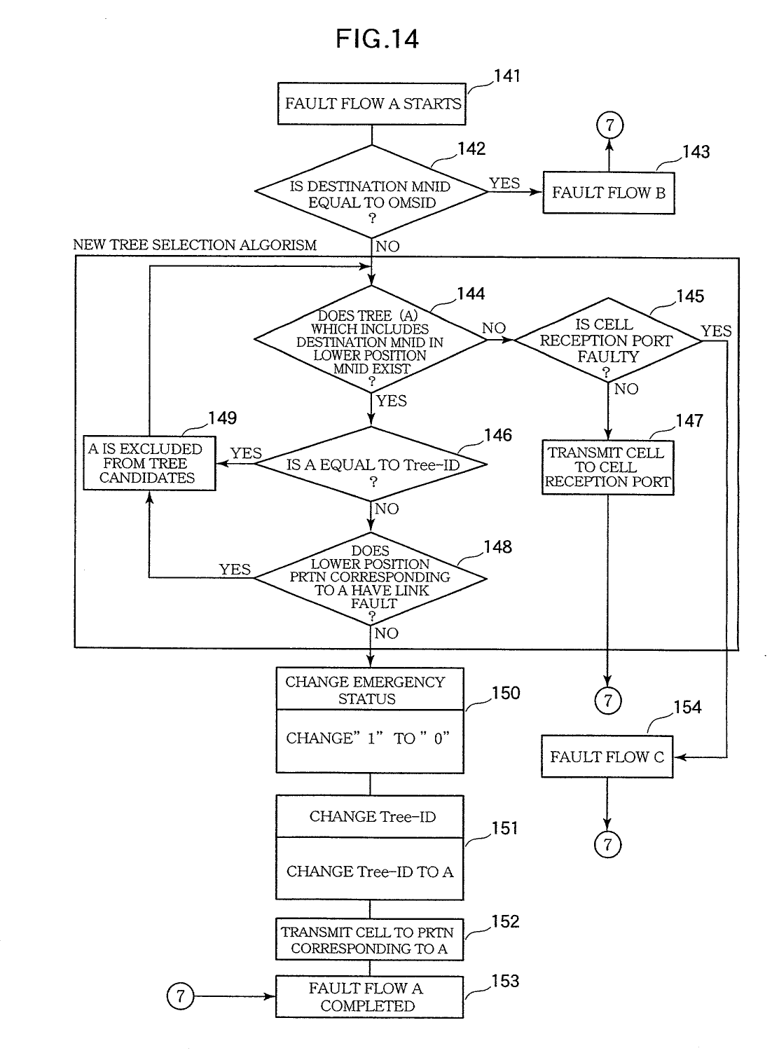

FIG. 14 is a view of the fault flow A for the routing process inside the communication node. The fault flow A determines whether the destination MN-ID inside the header matches the OMS-ID (142). When it matches, the user data enters a fault flow B (143). When it does not match, the destination MN-ID inquires the routine information section 20 whether there is a Tree-ID to be a new candidate who exists inside the lower position MN-ID (144). When there is no candidate, the user data enters a fault flow C (145, 154).

When the Tree-ID to be a new candidate exists, the destination MN-ID inquires the link status monitor section 21 of the disable or enable status of a port number to be at the lower side of that Tree-ID (146)(148). When the port number is in an operating status, it is determined to be capable of transmitting the user data and the EMS information inside the header is changed to [0] (150) so that a newly acquired Tree-ID is set on the Tree-ID (151) and the user data is transmitted to that port number (152). When the port number is in a non-operating status, the destination MN-ID inquires the link status monitor section 21 of the disable or enable status of the port number which received the user data and, when the port number is in an operating status, the user data is transmitted to that port (147). When the port number is in a non-operating status, the user data enters the fault flow C (154).

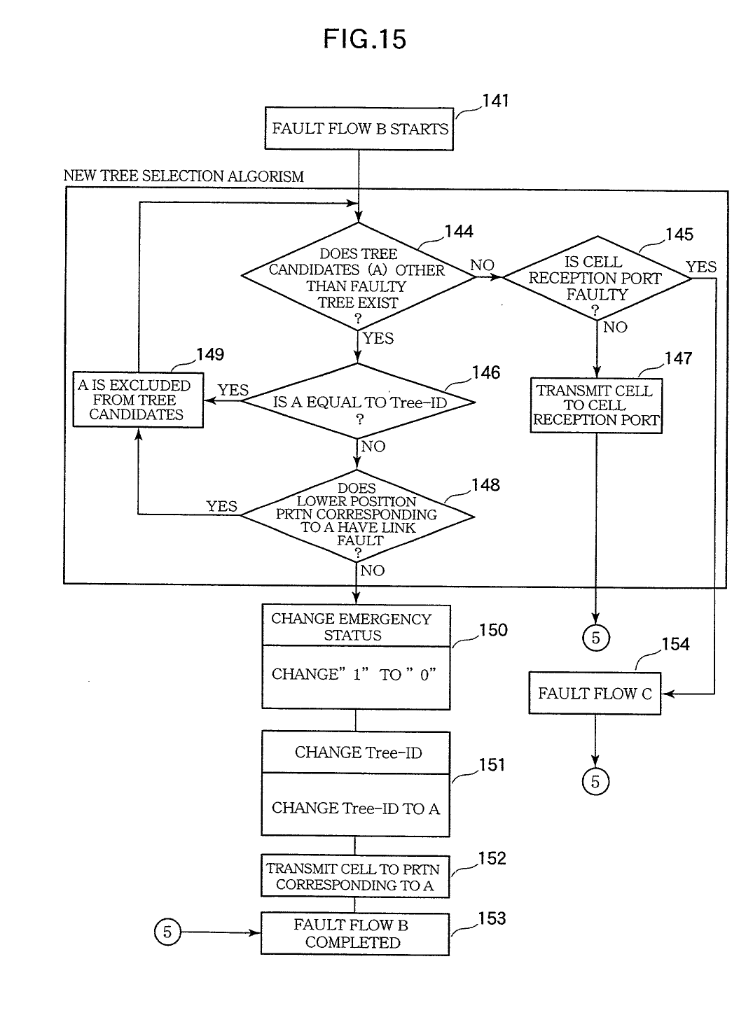

FIG. 15 is a view of the fault flow B for the routing process inside the communication node. The fault flow B inquires the route information section 20 whether there exists a Tree-ID to be a new candidate (162). In this case, all the Tree-IDs (except for the Tree-IDs on the header of the present user data under the present condition) can be utilized (because the upper position sides of all the virtual connection trees are connected to the access network terminating set). In the case where there exists a plurality of candidates, any one of them is selected (164). The fault flow B inquires the link status monitor section 21 of the disable or enable status of the upper position side port number of the newly selected Tree-ID (165) and, when the upper position side port number is in an operating status, the EMS is set to [0] (168) and the Tree-ID inside the header is set so as to be changed to a newly selected value (169), and the user data is transmitted from that port number (170). When the upper side port number is in a non-operating status, any Tree-ID from the remaining candidates can be selected (166) and its disable or enable status is inquired (163). This is repeated until the Tree-ID is all used up (167). When there is no candidate, the user data enters the fault flow C (172).

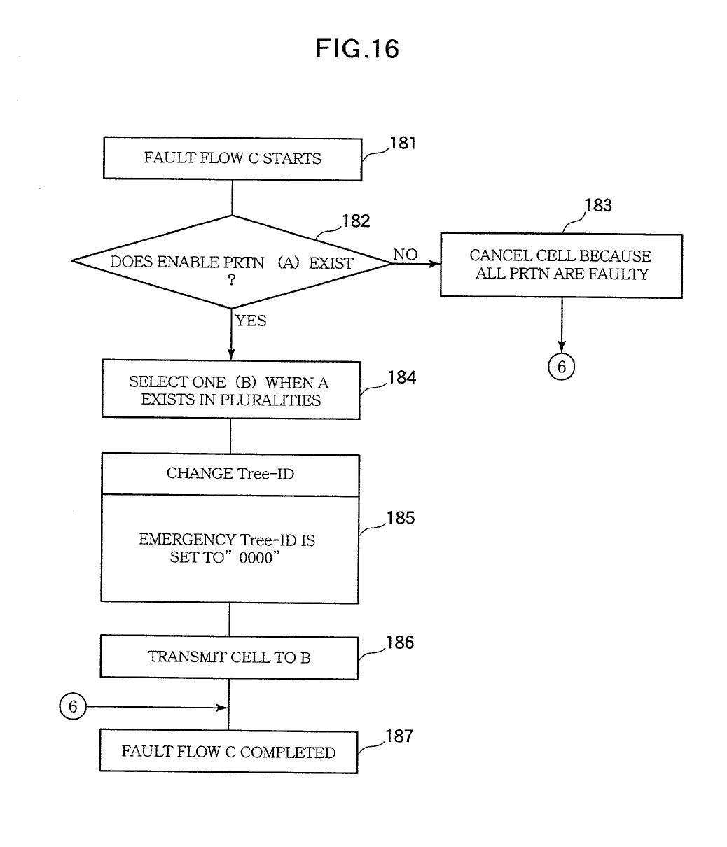

FIG. 16 is a view of the fault flow C for the routing process inside the communication node. The fault flow C inquires the link status monitor section 21 whether the port numbers in which the link condition is in an operating status exist (182). When one number exists, the port is selected and, when a plurality of numbers exists, any port number is selected (184) and defined as the user data transmit port (186). The Tree-ID is set to [0] (185) and the user data is transmitted (186). When there is no port number in an operating status, it is determined that there exists no link in the communication node that can relay, so that the user data is cancelled (183).

### FIRST EMBODIMENT

A first embodiment of the present invention will be described below by reference to FIGS. 4, 5, 6, 7, 8, 10, 13, 14 and 16.

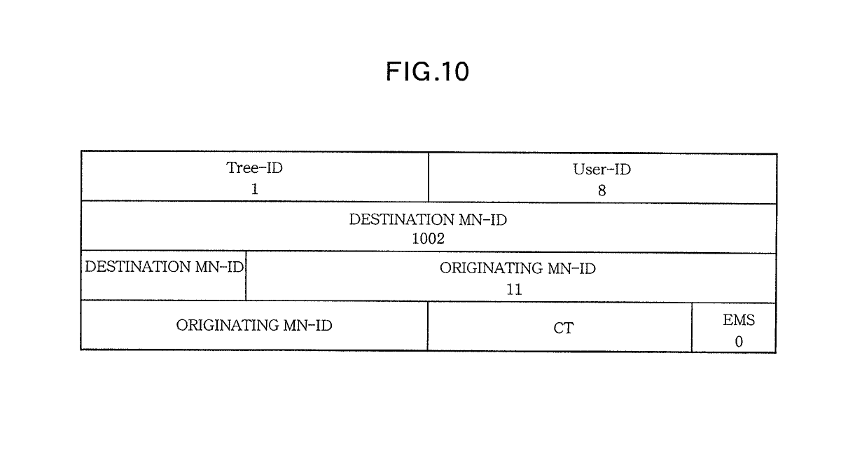

FIG. 10 shows one example of the header transmitted in the network on FIG. 4, which the user data has in possession. Suppose the case where this user data is relayed according to an algorism inside the communication node.

When the communication node A of FIG. 4 receives the user data via the port #2, FIG. 12 is put into a state of the main process flow (102). This port number received as above is maintained and utilized for subsequent processes. In (103), the destination MN-ID inside the header and the MN-ID of own station are compared. In FIG. 10, the value of the destination MN-ID is [1002], and the value of the MN-ID of own station is [35], [2] from FIG. 8, and it is evident that they do not match each other. Hence, the user data enters the relay process flow (104) from (103).

In the relay process flow of FIG. 13 (122), the value of the EMS inside the header is confirmed. When it is [1], the user data enters the fault flow A (123). When it is [0], the route information section 20 confirms the port number for transmitting the user data from the port number in which the user data was received as well as the value of the Tree-ID inside the header from the routing table of FIG. 5. In this case, the port #4 corresponds to that number.

In (125), the disable or enable status of the port number acquired as above is confirmed. The link status monitor section 21 confirms that the port number is in an operating status from the link condition table of FIG. 6. Hence, the present user data is transmitted from the port #4.

### SECOND EMBODIMENT

A second embodiment of the present invention will be described below by reference to FIGS. 4, 5, 6, 7, 8, 11, 13, 14, 15 and 16.

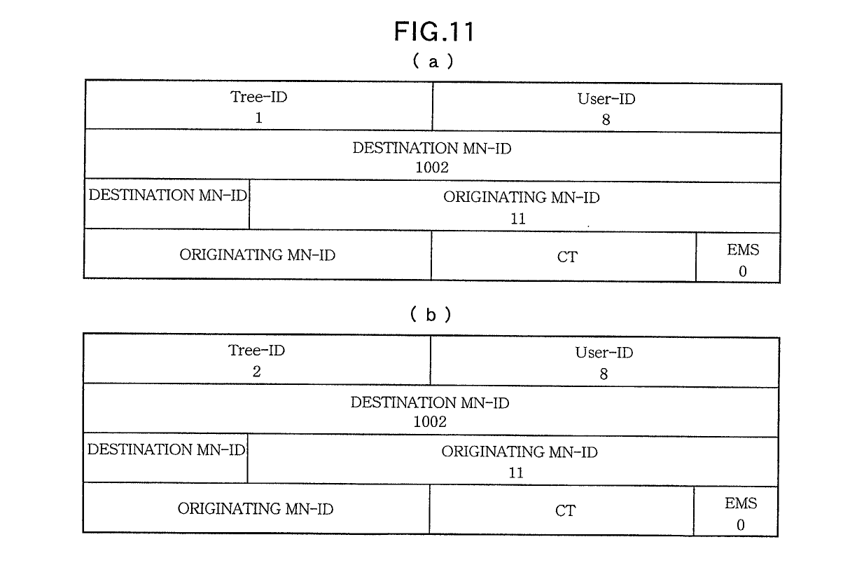

FIG. 11A shows one example of the header transmitted in the network of FIG. 4, which the user data has in possession. Suppose the case where this user data is relayed according to an algorism inside the communication node.

When the communication node A of FIG. 4 receives that particular user data via the port #2, FIG. 12 is put into a state of the main process flow (102). The port number received as above is maintained and utilized for subsequent processes. In (103), the destination MN-ID inside the header and the MN-ID of own station are compared. In FIG. 10, the value of the destination MN-ID is [1002], and the value of the MN-ID of own station is [35], [2] from FIG. 8, and it is evident that they do not match each other. Hence, the user data enters the relay process flow (104) from (103).

In the relay process flow of FIG.13 (122), the value of the EMS inside the header is confirmed. When it is [1], the user data enters the fault flow A (123). When it is [0], in (124), the route information section 20 confirms the port number for transmitting the user data from the port numbers in which the user data was received as well as the value of the Tree-ID inside the header from the routing table of FIG.5. In this case, the port #4 corresponds to that number.

In (125), the disable or enable status of the port number acquired as above is confirmed. The link status monitor section 21 confirms that the port number is not in an operating status from the link condition table of FIG. 6. Hence, the present user data can not be transmitted from the port #4.

In (126), the value of the EMS inside the header is changed from [0] to [1]. In (128), the user data enters the fault flow A.

In the fault flow A of FIG. 13, the values of the destination MN-ID inside the header and the OMS-ID are compared in (142). Since the value of the OMS-ID is [1001] and [1002 ] from FIG. 8, it is evident that the value matches that of the destination MN-ID inside the header. Hence, the user data enters the fault flow B in (143).

In the fault flow B of FIG. 15, since the user data can not be transmitted by the Tree-ID inside the header, other candidate for the Tree-ID is retrieved. The route information section 20 obtains the Tree-ID #2 from the routing table of FIG. 5. It also confirms the upper position side port number. Since the user data has the OMS-ID in the destination MIN-ID inside the header, it transmits the OMS-ID to the upper position side. However, since the upper position sides of all the virtual connection trees are connected to the access network terminating set, all other than the Tree-ID inside the header can be made as the candidates.

In (165), the disable or enable status of the port #3 as acquired in the above is confirmed. The link status monitor section 21 confirms that the port number is in an operating status from the link condition table of FIG. 5. Hence, the present user data can be transmitted from the port #3.

In (168) and (169), the value of the Tree-ID inside the header is changed to #2, and the value of the EMS is changed from [1] to [0]. Hence, the header becomes as shown in FIG. 11B. In (170), the user data is transmitted from the port #3.

As described above, since the communication node can independently perform the change of the virtual connection tree when a fault occurs (the disable and enable status is non-operating status) in the link to which it is connected, it is possible to quickly avoid the fault.

As described above, according to the present invention, by using the communication protocol of a lower position layer in each communication node inside the access network, the transmission inside the access network can be effectively performed. Since the communication processing is performed by the lower position layer, this can contribute to reduce the so-called processing delay in each communication node. Moreover, since the exchange of the information relating to the condition of the circuit inside the access network and the like is performed only between the access network terminating set and the communication nodes which the disable or enable status of the communication link passages changed, it is reduced in contrast to the case where all the communication nodes are notified, and it is possible to allot those bandwidths spared for traffics of the subscribers.

What is claimed is:

1. An access network system having communication nodes capable of receiving and transmitting the information disposed at a plurality of cross-points, wherein each communication node mutually constitutes an access network accessible in a cross state at the communication link and comprises an access network terminating set for terminating the access network, the access network terminating set comprising:
means for constructing a plurality of connection communication passages having a logical tree structure that hypothetically connects each communication node on said communication passages;
means for notifying all the communication nodes of the information relating to the constructed connection communication passages;
means for controlling communication traffics allotted to said plurality of connection communication passages and changing allotment conditions of communication traffics among the connection communication passages;
means for receiving the information relating to disable or enable status change from the communication node; and
means for terminating the communication processing inside said access network and executing a gateway function with an outside network.

2. The access network system according to claim 1, wherein said communication node comprises:
means for judging disable or enable status of a communication link passage connected to it;
means for notifying said access network terminating set of the judgment result of the means; and
means for receiving the information relating to the connection communication passages notified from the access network terminating set and adapting it as the route information.

3. The access network system according to claim 1, wherein said communication node comprises means for performing independently the switching of the connection communication passages when the disable or enable status of said communication link passages has changed.
